(19) United States
(12) Patent Application Publication
(10) Pub. No.: US 2024/0010472 A1
(43) Pub. Date: Jan. 11, 2024

(54) DOUBLE-LOCKING HOOKING SYSTEM INTENDED FOR TRANSPORTING A LOAD OUTSIDE AN AIRCRAFT

(71) Applicant: AIRBUS HELICOPTERS, Marignane Cedex (FR)

(72) Inventors: Maxime LEFORT, Salon De Provence (FR); Eric SZYMANSKI, Chateauneuf Les Martigues (FR)

(73) Assignee: AIRBUS HELICOPTERS, Marignane Cedex (FR)

(21) Appl. No.: 18/209,545

(22) Filed: Jun. 14, 2023

(30) Foreign Application Priority Data
Jul. 8, 2022 (FR) 2207013

(51) Int. Cl. B66C 1/36; B64C 27/06; B66D 1/54; B64D 1/22

(52) U.S. Cl. CPC B66C 1/36; B64C 27/06; B66D 1/54; B64D 1/22

(57) ABSTRACT

A double-locking hooking system comprising a structure, a hook that is able to move in relation to the structure between a closed position and an open position, and an immobilization system for immobilizing the hook in the closed position (18). The immobilization system comprises two immobilization devices each provided with at least one movable stop. The stops are in contact with the hook when the hook is in the closed position in order to immobilize the hook in the closed position. The two immobilization devices therefore each allow the hook to be immobilized in the closed position, by means of the stops, independently of each other. In order to position the hook in the open position, the two immobilization devices need to be activated in order for the stops to be moved to release the hook.

### CROSS-REFERENCE TO RELATED APPLICATIONS

This application claims priority to French patent application No. FR 22 07013 filed on Jul. 8, 2022, the disclosure of which is incorporated in its entirety by reference herein.

### TECHNICAL FIELD

The present disclosure lies in the field of systems for hooking a load outside an aircraft.

The present disclosure relates to a double-locking hooking system intended for transporting a load outside an aircraft.

### BACKGROUND

An aircraft and, more particularly, a rotorcraft such as a helicopter, may optionally be equipped with an installation for transporting external loads. For this purpose, the aircraft generally comprises a load-bearing structure to which a rotating or non-rotating hooking system is attached.

A sling may then be hooked to this hooking system in order to allow heavy external loads to be attached, lifted and transported. The hooking system may also allow the external load to be released during flight, in order to release this external load at a determined location or in the event of an emergency such as a distress situation, for example.

The hooking system may also allow persons to be transported, for example along a rope attached to the hooking system or in a cabin hung from this hooking system, via a cable or a sling.

The hooking system must therefore allow a rope or a sling, for example, to be installed easily and possibly to be released from the cockpit of the aircraft, in particular by the pilot of the aircraft, or the cabin of the aircraft by an operator. In this case, the hooking system must therefore comply with constraints arising from operations, certification and safety criteria.

The hooking system must also meet safety standards for the transportation of persons outside the aircraft. For example, the probability of occurrence of an event considered to be catastrophic, in particular the accidental opening of the hooking system, must not exceed a threshold, for example 10-9.

Such a hooking system comprises, for example, a structure and a hook. The hook is able to rotate in relation to the structure between two positions, i.e., between an open position and a closed position.

In the open position, a space is created between one end of the hook and the structure in order to allow a loop or a ring situated at one end of a rope or a sling to be fitted. In the closed position, this space is smaller, or indeed non-existent, in order to prevent the loop or the ring from escaping from the hooking system.

The load transported by the rope or the sling is thus supported by the hook.

The hooking system comprises an immobilization or locking device for keeping the hook in the closed position in order to prevent the hook from suddenly rotating and opening unintentionally, for example under the effect of the weight of the transported load or as a result of turbulence or impact. This immobilization or locking device may also be controlled in order to allow the hook to shift from the closed position to the open position. The immobilization or locking device may be actually manually or by a spring, an electric motor or a pneumatic or hydraulic actuator in order to allow the hook to shift from the closed position to the open position. The immobilization or locking device may be actuated by an operator situated in the vicinity of the hooking system or indeed at a distance from it, for example by the pilot of the aircraft, from the cockpit of the aircraft.

The following documents give examples of hooking systems comprising a structure, a hook and an immobilization device.

Document US 2005/0258658 discloses a hooking system whose immobilization device is provided with a security pin. The security pin may be inserted into a predetermined location in order to link the immobilization device to the structure after a load has been attached to the hooking system, thus preventing the hook from moving and consequently opening.

Documents U.S. Pat. Nos. 3,845,978 and 8,016,333 disclose hooking systems whose immobilization device comprises two immobilization elements arranged in series in order to allow the hook to open.

The first immobilization element is a latch that is able to rotate between an immobilization position holding the hook in its closed position and a release position allowing the hook to pivot to its open position. The second immobilization element is a rotating component that is able to immobilize the first immobilization element in its immobilization position and allow the first immobilization element to rotate to its release position. The first immobilization element and the second immobilization element thus constitute a single chain of forces resulting in the hook being immobilized in the closed position or being opened. If one element of this chain fails, the hook may unintentionally or accidentally open.

According to document U.S. Pat. No. 8,016,333, the movements of the second immobilization element may be controlled electrically with an electric motor.

According to document U.S. Pat. No. 3,845,978, the movements of the second immobilization element may be controlled electrically with an electric motor or manually via a handle or a cable.

Moreover, according to document U.S. Pat. No. 3,845,978, the hooking system comprises a linkage and a rod that make it possible, when the transported load is on the ground and the weight of this load is no longer acting on the hook, to control the motor in order to move the second immobilization element, causing the hook to open.

Document GB 2 513 646 describes a loading hook comprising a structure, a hook that is able to rotate and a locking mechanism allowing the hook to be released so that it moves from a closed position to an open position. The locking mechanism comprises a latch and a locking latch. The latch comprises two arms, the hook being locked at one of these arms in the closed position.

The locking latch comprises two arms and cooperates with the latch by means of a first arm so that, in a locked position, it prevents the latch from moving and, in an unlocked position, it allows the latch to move in order to allow it to release the hook. The second arm of the locking latch comprises a roller than comes to bear against a stop of the hook in order to immobilize it in the closed position.

This locking mechanism therefore provides two locking points acting separately on the hook, via the latch and the locking latch. However, these two locking points are not independent of each other, because the rotation of the locking latch simultaneously causes the roller of the locking latch to move and the latch to be released. The two locking points are therefore dependent on each other, the release of a first locking point resulting in the release of the second locking point.

Finally, the technological background of the disclosure comprises documents U.S. Pat. Nos. 4,201,410 and 4,678,219.

### SUMMARY

An object of the present disclosure is thus to propose an alternative solution for a hooking system for hooking an load outside an aircraft that helps overcome the above-mentioned limitations and aims to secure the closure of the hook of this hooking system.

The present disclosure relates to a double-locking hooking system. This double-locking hooking system is, in particular, intended to be installed on an aircraft, for example being attached to the airframe of this aircraft, and to allow a load to be transported outside the aircraft, for example by means of a sling or a rope attached to the double-locking hooking system.

According to the disclosure, a double-locking hooking system comprises a structure, a hook that is able to move in relation to the structure between a closed position and an open position, and an immobilization system for immobilizing the hook in the closed position.

The hook may, for example, be able to rotate in relation to the structure about an axis of rotation, between the closed position and the open position. In the open position, a sling or a rope may be placed on the hook in order to be supported by the hooking system according to the disclosure or indeed be removed from the hook. In the closed position, the sling or the rope is immobilized on the hook and cannot be removed from the hooking system according to the disclosure.

This double-locking hooking system is remarkable in that the immobilization system comprises at least two immobilization devices, each immobilization device comprising at least one movable stop, the stops being in contact with the hook when the hook is in the closed position, each immobilization device immobilizing the hook in the closed position by means of its at least one stop independently of the other immobilization device.

As a result, the hooking system according to the disclosure allows, at the very least, the double locking of the hook, by virtue of the at least two immobilization devices each provided with one or more stops, thus securely locking of the hook.

Indeed, these at least two immobilization devices of the immobilization system make it possible, separately, to keep the hook of the hooking system in the closed position, by means of each of the stops.

Therefore, in the event that one of these at least two immobilization devices fails, for example due to one of the components of this immobilization device breaking, such as a stop, the hook is still kept in the closed position by the other immobilization device.

The transportation of a load or persons with this hooking system, using a sling and a rope, for example, is therefore advantageously secured.

Furthermore, in order to position the hook in the open position and thus release the sling or the rope, as the case may be, the at least two immobilization devices must be activated so that all of the stops are moved in order to allow the hook to be opened. The at least two immobilization devices may be activated simultaneously or in sequence.

For example, the immobilization system of the hooking system according to the disclosure comprises two immobilization devices.

The hooking system according to the disclosure may comprise one or more of the following features, taken individually or in combination.

According to one possibility, the stops may be in contact with the hook separately for each immobilization device when the hook is in the closed position. For example, the stops of the immobilization devices are in contact with the hook in different areas of the hook, such as one end of the hook and a protuberance protruding from the hook, for example.

According to another possibility compatible with the preceding possibility, each immobilization device may comprise an actuator controlling the movement of its at least one stop. The actuator may for this purpose be linked to the corresponding stop or stops directly or via a movement transfer or reduction device. A movement of the stop caused by the actuator thus releases the hook from this stop. Moreover, each immobilization device comprises its own actuator that is separate from the actuator of the other immobilization device, thus contributing to the security of the hooking system. After the activation of the immobilization devices and the release of the hook from all of the stops, the hook moves from the closed position to the open position, for example under its own weight.

An actuator may comprise an electric motor rotating the stop or indeed a connecting rod causing the stop to move, for example. Alternatively, an actuator may comprise a jack, that may be electric, pneumatic or hydraulic, for example, causing the stop or indeed a connecting rod carrying a stop to move.

According to another possibility compatible with the preceding possibilities, at least one immobilization device may comprise at least one connecting rod that is able to rotate and is provided with a stop, the actuator controlling the movement of this connecting rod. Therefore, a particular one of said at least one connecting rod may comprise a stop of this immobilization device. This particular connecting rod is able to rotate in relation to the structure of the hooking system. The actuator may then be linked to this particular connecting rod directly, or via a movement transfer or reduction device. The actuator may also be linked to a transfer connecting rod linked to this particular connecting rod. A rotational movement of the particular connecting rod caused by the actuator therefore allows the stop to move in order, in particular, to release the hook from the stop of this immobilization device.

For example, one of the immobilization devices may comprise a stop and a single connecting rod referred to, for example, as the “immobilization connecting rod”. The immobilization connecting rod is able to rotate and comprises the stop. The actuator may act on the immobilization connecting rod in order to move the stop and therefore release the hook from this stop.

According to another example, one of the immobilization devices may comprise a stop and two connecting rods that are able to rotate, the two connecting rods comprising a swiveling connecting rod and a locking connecting rod. The swiveling connecting rod comprises, for example, a first arm and a second arm, whereas the locking connecting rod comprises a third arm. The first arm may comprise the stop, the third arm bearing against the second arm in order to prevent the swiveling connecting rod from moving when the hook is in the closed position, the stop carried by the first arm being in contact with the hook. The actuator may act on the third arm in order to release the second arm from the swiveling connecting rod and therefore allow the swiveling connecting rod and the stop to move in order to release the hook from this stop. The actuator may then act directly on the locking connecting rod in order to release the second arm and allow the swiveling connecting rod to move in order to release the hook from the two stops.

These two examples may be combined. Moreover, in these cases, the immobilization connecting rod and the swiveling connecting rod may be coaxial and therefore able to move independently about the same pivot axis, being moved by two separate and independent actuators.

According to another example compatible with the preceding examples, one of the immobilization devices may comprise two stops and two connecting rods, the two connecting rods comprising a swiveling connecting rod and a locking connecting rod. The swiveling connecting rod comprises, for example, a fourth arm and a fifth arm and the locking connecting rod comprises a sixth arm and a seventh arm. The fourth arm may comprise one of the two stops, the sixth arm then bearing against the fifth arm in order to prevent the swiveling connecting rod from moving, the seventh arm comprising the other of the two stops. The actuator may then act directly on the locking connecting rod in order to release the fifth arm and allow the swiveling connecting rod to move in order to release the hook from the two stops.

According to another possibility compatible with the preceding possibilities, the hook may comprise a lower beam, a lateral part, a top part and an open space arranged between the lower beam and the top part, the hook being able to rotate in relation to the structure in the lateral part or the top part. The lateral part or the top part are for example rotationally hinged to the structure by means of a pivot link.

Therefore, when the hook is in the open position, the open space of the hook allows the sling or the rope to be positioned on the lower beam of this hook or indeed allows the sling or the rope to be disengaged from the lower beam of this hook and therefore from the hooking system according to the disclosure.

In the closed position, this open space of the hook is at least partially or indeed completely closed by the structure of the hooking system, meaning that the sling or the rope is held on the lower beam of the hook and therefore cannot escape from the hooking system according to the disclosure.

The stops of one of the immobilization devices may bear against a first part chosen from the lateral and top parts and the lower beam when the hook is in the closed position and the other immobilization device may comprise a single stop bearing against a second part chosen from the lateral and top parts and the lower beam when the hook is in the closed position. The first part and the second part may be separate from each other.

Moreover, the stops can keep the hook in the closed position by bearing against different parts chosen from the lateral and top parts and the lower beam of the hook, thus helping hold the hook securely in the closed position.

According to a first variant, each immobilization device comprises a single connecting rod. One of the immobilization devices may comprise a single stop bearing against a first part chosen from the lateral and top parts and the lower beam when the hook is in the closed position and the other of the immobilization devices may comprise a single stop bearing against a second part chosen from the lateral and top parts and the lower beam when the hook is in the closed position. The first part and the second part may advantageously be separate from each other.

According to a second variant, at least one of the two immobilization devices may comprise two stops and two connecting rods that are able to rotate and are provided respectively with the two stops. The actuator of this immobilization device may then act on one of the two connecting rods, directly or via a movement reduction device.

For example, one of the immobilization devices may comprise a single stop bearing against a first part chosen from the lateral and top parts and the lower beam when the hook is in the closed position and the other of the immobilization devices may comprise two connecting rods, each connecting rod carrying a stop, the two stops respectively bearing against a second part and a third part chosen from the lateral and top parts and the lower beam when the hook is in the closed position. The first part, the second part and the third part may advantageously be separate from each other.

According to another possibility compatible with the preceding possibilities, the hooking system according to the disclosure may comprise an emergency release device provided with two wires and an emergency actuator connected to the two wires. Each wire is connected to an immobilization device and each immobilization device is connected to a wire. Each wire therefore allows the movement of the stop or stops of the immobilization device to which it is connected to be controlled. This movement of the stop may be controlled by the wire directly, the wire being connected to the stop, or via one or more connecting rods, the wire being connected to a connecting rod. A ball end may for example be crimped onto the end of the wire and held by a fork of the immobilization device.

The two wires connected to the two immobilization devices are moved by the same emergency actuator. The emergency actuator may for example comprise a manual control, an electric motor, a jack or a pyrotechnic device.

The emergency release device of the hooking system therefore allows the hook to be moved from the closed position to the open position while the aircraft is flying, in order to quickly release the transported load hooked to the hooking system.

Furthermore, an aircraft may comprise a double-locking hooking system as described above. The double-locking hooking system may be attached to or hanging from an airframe of the aircraft, for example being under the airframe or on the side of the airframe. A sling or a rope may be hung from the hook of the double-locking hooking system in order to allow the aircraft to transport a load or persons.

### BRIEF DESCRIPTION OF THE DRAWINGS

The disclosure and its advantages appear in greater detail in the context of the following description of embodiments given by way of illustration and with reference to the accompanying figures, wherein:

FIG. 1 is a perspective view of a hooking system according to the disclosure in the closed position;

FIG. 2 is a cross-sectional view of a hooking system according to the disclosure in the closed position;

FIG. 3 is another cross-sectional view of a hooking system according to the disclosure in the closed position;

FIG. 4, is another cross-sectional view of the hooking system of FIG. 2 in the open position;

FIG. 5 is a cross-sectional view of another hooking system according to the disclosure in the closed position;

FIG. 6, is another cross-sectional view of the hooking system of FIG. 5 in the open position;

FIG. 7 is a cross-sectional view of a hooking system according to the disclosure provided with an emergency actuator; and

FIG. 8 is a side view of an aircraft equipped with a hooking system according to the disclosure.

### DETAILED DESCRIPTION

Elements that are present in more than one of the figures are given the same references in each of them.

The notions of “right”, “left”, “upper”, “lower”, “bottom” and “top” referred to in the description are to be understood in a relative manner and as seen by an observer viewing the figures.

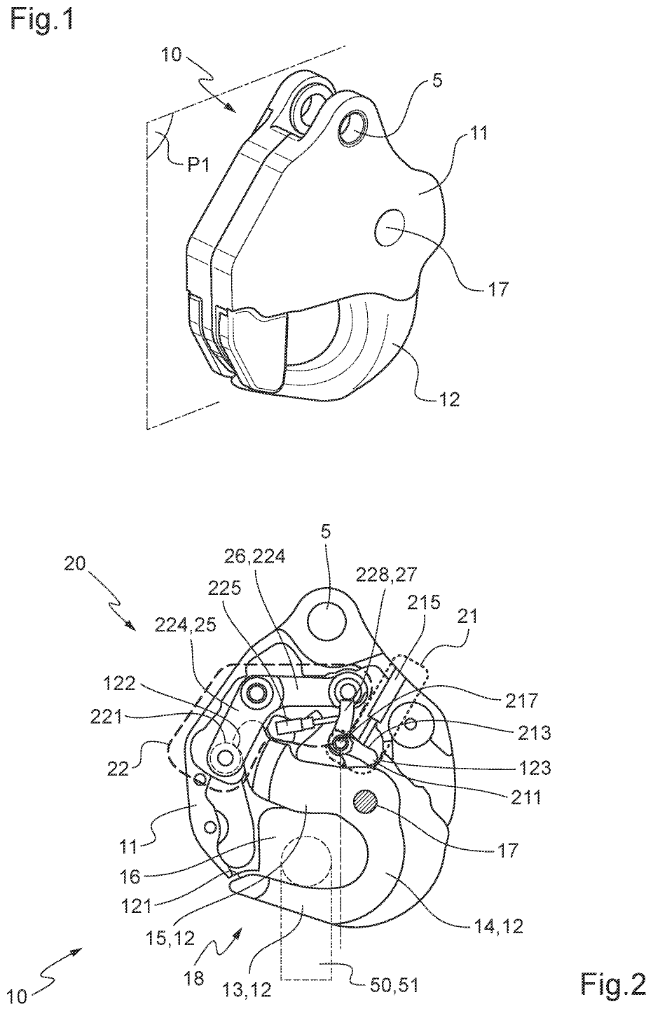

FIG. 1 shows a double-locking hooking system 10 comprising a structure 11 and a hook 12. The hook 12 is able to move in relation to the structure 11 and may be moved, for example rotated about a rotation shaft 17, between a closed position and an open position. The hook 12 is shown in the closed position in FIG. 1. The hooking system 10 also comprises an immobilization system 20 for keeping the hook 12 in the closed position. The structure 11 may optionally comprise a through-hole 5. This hole is intended to attach the hooking system 10, for example to a vehicle, in particular to an aircraft.

FIGS. 2 to 6 show cross-sectional views according to the plane P1 of this double-locking hooking system 10, the hook 12 being in the closed position 18 in FIGS. 2, 3 and 5, and in the open position 19 in FIGS. 4 and 6.

As shown in the figures, the hook 12 may comprise a lower beam 13, a lateral part 14, a top part 15 and an open space 16 arranged between the lower beam 13 and the top part 15. The hook 12 may for example be substantially U-shaped or C-shaped.

A sling 50 is also shown in dashed lines in FIGS. 2 to 6, this sling 50 being positioned on the lower beam 13 of the hook 12. More specifically, a loop 51 forming one end of the sling 50 is hooked to the lower beam 13.

The hook 12 is able to move in relation to the structure 11. For example, the hook 12 is able to rotate in relation to the structure 11 about a rotation shaft 17 in order to shift from the closed position 18 to the open position 19, and vice versa. The hook 12 may be able to move about the rotation shaft 17 in the top part 15, as shown in the figures. The rotation shaft 17 is, for example, secured to the structure 11, and passes through the lateral part 14 of the hook 12. A bearing or a rolling bearing may optionally be positioned between the lateral part 14 and the rotation shaft 17 in order to facilitate the rotation of the hook 12 about this rotation shaft 17.

Alternatively, the hook 12 may be able to move about the rotation shaft 17 in the top part 15.

In the closed position 18, the open space 16 is completely closed by the structure 11 of the hooking system 10. The loop 51 of the sling 50 therefore cannot exit the hook 12. The loop 51 is therefore held on the lower beam 13 of the hook 12 and cannot escape from the hooking system 10.

In the open position 19, there is clearance between one end of the hook 12, i.e., the end 121 of the lower beam 13, and the structure 11. The loop 51 of the sling 50 may therefore be inserted through the open space 16 at this clearance and positioned on the lower beam 13 of the hook 12 in order to hook the sling 50 to the hooking system 10 or, conversely, the loop 51 may be withdrawn via the open space 16 at this clearance in order to remove the sling 50 from the hooking system 10.

The immobilization system 20 is provided with at least two immobilization devices 21, 22, 23, 24. Each immobilization device 21, 22, 23, 24 comprises at least one movable stop 211, 221, 231, 241, 242 and one actuator 215, 225, 235, 245 for moving said at least one stop 211, 221, 231, 241, 242 in relation to the structure 11. In the examples shown, the immobilization system 20 comprises two immobilization devices 21, 22, 23, 24. However, an immobilization system 20 may comprise more than two immobilization devices 21, 22, 23, 24, for example three immobilization devices.

As shown in FIGS. 2 to 4, the immobilization system 20 may comprise, for example, a right-hand immobilization device 21 and a left-hand immobilization device 22 respectively provided with a single right-hand stop 211 and a single left-hand stop 221. The two right-hand 211 and left-hand 221 stops bear respectively against a first part and a second part chosen from the lower beam 13, the lateral part 14 and the top part 15. For example, the right-hand stop 211 of the right-hand immobilization device 21 bears against the lateral part 16, in particular a protuberance 123 of the lateral part 16, whereas the left-hand stop 221 of the left-hand immobilization device 22 bears against the top part 15 of the hook 12, in particular its end 122, when the hook 12 is in the closed position 18. The first part and the second part are therefore advantageously separate from each other.

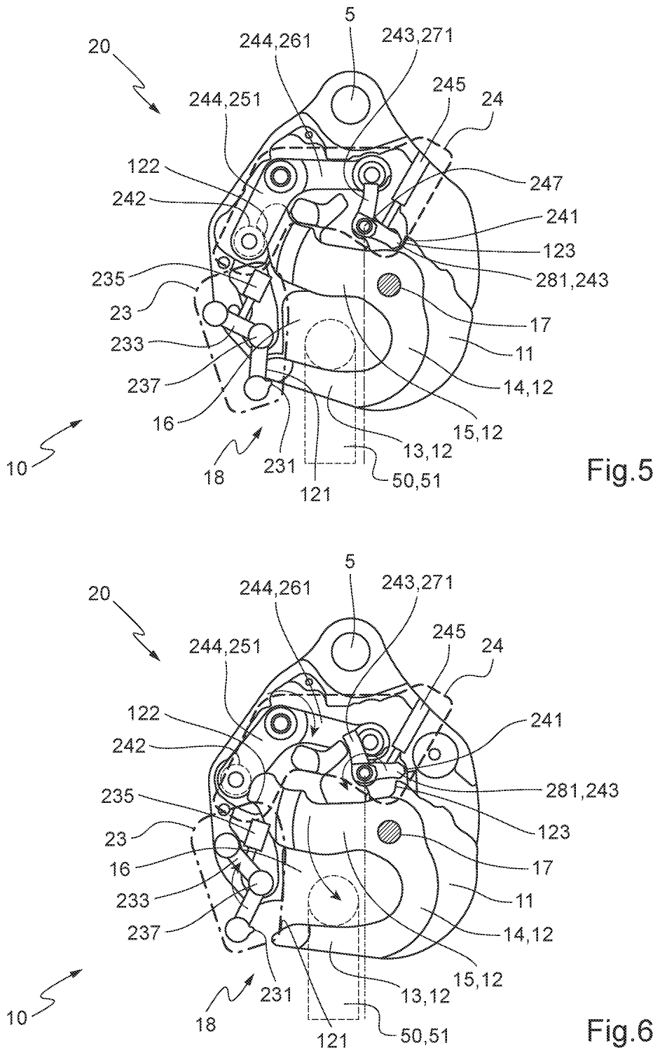

Alternatively, at least one of the immobilization devices 21, 22, 23, 24 may comprise two stops 241, 242. According to the example shown in FIGS. 5 and 6, the immobilization system 20 may comprise a lower immobilization device 23 provided with a single lower stop 231 and an upper immobilization device 24 provided with a right-hand upper stop 241 and a left-hand upper stop 242. The right-hand lower stop 231 of the lower immobilization device 23 bears, for example, against the end 121 of the lower beam 13 and the two right-hand 241 and left-hand 242 upper stops of the left-hand immobilization device 24 respectively bear against the end 122 of the top part 15 and against the protuberance 123 of the lateral part 16 of the hook 12 when the hook 12 is in the closed position 18.

The actuator 215, 225, 235, 245 of each immobilization device 21, 22, 23, 24 may directly control the movement of the stop or stops 211, 221, 231, 241, 242 of an immobilization device 21, 22, 23, 24, without acting on the movement of the stop or stops 211, 221, 231, 241, 242 of another immobilization device 21, 22, 23, 24.

Alternatively, the actuator 215, 225, 235, 245 of each immobilization device 21, 22, 23, 24 may control the movement of the stop or stops 211, 221, 231, 241, 242 of this immobilization device 21, 22, 23, 24 via a connecting rod, without acting on the movement of the stop or stops 211, 221, 231, 241, 242 of another immobilization device 21, 22, 23, 24.

An immobilization device 21, 22, 23, 24 may thus comprise at least one connecting rod 213, 223, 233, 243, 244 that is able to rotate in relation to the structure 11 and is provided with a stop 211, 221, 231, 241, 242, the actuator 215, 225, 235, 245 controlling the movement of the connecting rod 213, 223, 233, 243, 244, and therefore of the stop 211, 221, 231, 241, 241 of this connecting rod 213, 223, 233, 243, 244.

For example, the right-hand immobilization device 21 shown in FIGS. 2 to 4 may be provided with an immobilization connecting rod 213 carrying the right-hand stop 211 and a right-hand actuator 215 connected to this immobilization connecting rod 213. The immobilization connecting rod 213 is able to rotate about a pivot axis 217. According to this example, the left-hand immobilization device 22 may comprise two connecting rods 223, 228, one being a swiveling connecting rod 223 and one being a locking connecting rod 228, as well as a left-hand actuator 225. The swiveling connecting rod 223 comprises a first arm 25 and a second arm 26 that are attached to each other, the first arm 25 carrying the stop 221.

The locking connecting rod 228 comprises a third arm 27 that bears against the second arm 26 when the hook 12 is in the closed position. The third arm 27 thus prevents the swiveling connecting rod 223 and, therefore, the left-hand stop 221, from moving, as shown in FIG. 2. In FIG. 2, the left-hand stop 221 also bears against the end 122. The hook 12 is then immobilized in the closed position 18.

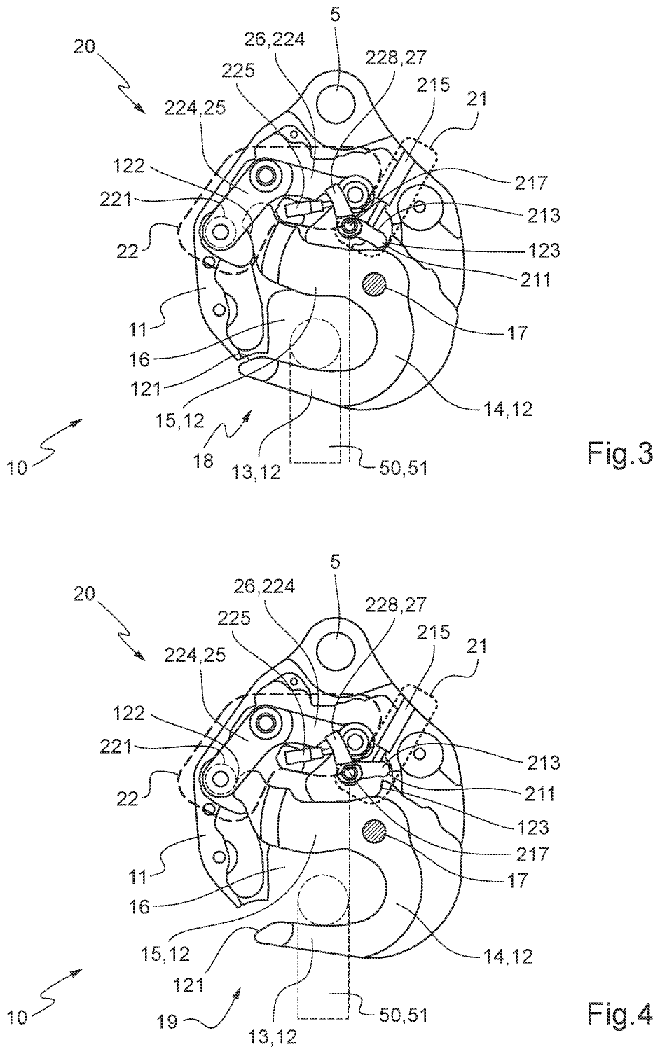

The left-hand actuator 225 is connected to the third arm 27 and may control the movement of the third arm 27 about the pivot axis 217, causing the swiveling connecting rod 223 and, therefore, the left-hand stop 221, to move, as shown in FIG. 3. The left-hand stop 221 then no longer bears against the end 122 and therefore no longer prevents the hook 12 from moving. However, the right-hand stop 211 still bears against the protuberance 123 by virtue of the right-hand actuator 215. The hook 12 is thus still immobilized in the closed position 18.

Then, by virtue of the right-hand actuator 215, the immobilization connecting rod 213 and the right-hand stop 211 can be moved, as shown in FIG. 4, so that the right-hand stop 211 no longer bears against the protuberance 123. The hook 12 is then no longer immobilized in the closed position 18, since neither the right-hand stop 211 nor the left-hand stop 221 prevents it from moving to the open position 19.

According to the example shown in FIGS. 2 to 4, the immobilization connecting rod 213 and the swiveling connecting rod 223 may be able to move in relation to each other about the same pivot axis 217. Alternatively, the immobilization connecting rod 213 and the swiveling connecting rod 223 may be able to rotate about separate axes.

According to another example shown in FIGS. 5 and 6, the upper immobilization device 24 may be provided with an upper actuator 245 and two connecting rods 243, 244 that are able to rotate about separate axes and respectively comprise the right-hand upper stop 241 and the left-hand upper stop 242. The upper immobilization device 24 may thus comprise a locking connecting rod 243 and a swiveling connecting rod 244. The swiveling connecting rod 244 comprises a fourth arm 251 and a fifth arm 261 that are attached to each other, and the locking connecting rod 243 comprises a sixth arm 271 and a seventh arm 281 that are attached to each other. The fourth arm 251 comprises the left-hand upper stop 242 that bears against the end 122 of the top part 15 when the hook 12 is in the closed position 18. The sixth arm 271 bears against the fifth arm 261 in order to prevent the swiveling connecting rod 244 from moving. The seventh arm 281 comprises the right-hand upper stop 241 that bears against the protuberance 123 arranged on the lateral part 14 when the hook 12 is in the closed position 18.

The upper actuator 245 is connected to the locking connecting rod 243 and controls its movement in order to simultaneously allow the right-hand upper stop 241 and the swiveling connecting rod 244, and therefore the left-hand upper stop 242, to move. The two right-hand 241 and left-hand 242 upper stops then no longer prevent the hook 12 from moving.

The lower immobilization device 23 comprises a lower connecting rod 235 that is able to rotate and carries the lower stop 231 and a lower actuator 235. The lower actuator 235 is connected to the lower connecting rod 235 and controls its movement so as to allow the lower stop 231 to move in order to release the hook 12.

Thus, if a single immobilization device 21, 22, 23, 24 is activated or fails, causing its stop or stops 211, 221, 231, 241, 242 to move or causing a stop 211, 221, 231, 241, 242 or a connecting rod 2113, 223, 233, 243, 244, as the case may be, to break, the hook 12 is advantageously still kept in the closed position 18 by virtue of the other immobilization device 21, 22, 23, 24.

In order to allow the hook 12 to move from the closed position 18 to the open position 19 and thus release the sling 50, all the immobilization devices 21, 22, 23, 24 of the hooking system must be activated in order to move their respective stops 211, 221, 231, 241, 242, thus releasing the hook 12. The immobilization devices 21, 22, 23, 24 may be activated simultaneously or in sequence. For example, an operator may control the actuator 215, 225, 235, 245 of each immobilization device 21, 22, 23, 24 by means of a human-machine interface, such as a switch or a button or indeed a screen provided with a touch panel.

Each actuator 215, 225, 235, 245 may, for example, comprise an electric motor controlling the rotation of a stop 211, 221, 231, 241, 242 or a connecting rod 213, 223, 233, 243, 244, as the case may be, directly or via a reduction device.

Alternatively, each actuator 215, 225, 235, 245 may comprise an electric, pneumatic or hydraulic jack, controlling a movement of the stop 211, 221, 231, 241, 242 or a connecting rod 213, 223, 233, 243, 244, as the case may be.

Therefore, regardless of the embodiment of the hooking system 10, the hook 12 may remain in the closed position 18, including after a failure of one of the immobilization devices 21, 22, 23, 24, for example a stop 211, 221, 231, 241, 242 breaking or indeed the top part 15 of the hook 12 breaking. For example, if this top part 15 has broken, the protuberance 123 of the lateral part 14 and/or the end 121 of the lower beam 13 still allow the hook 12 to bear against a stop 211, 231, 241 and, therefore, to be immobilized in the closed position 18.

Therefore, each immobilization device 21, 22, 23, 24 itself immobilizes the hook 12 in the closed position 18 by means of at least one stop 211, 221, 231, 241, 242, independently of the other immobilization device 21, 22, 23, 24, including when the other immobilization device 21, 22, 23, 24 has failed.

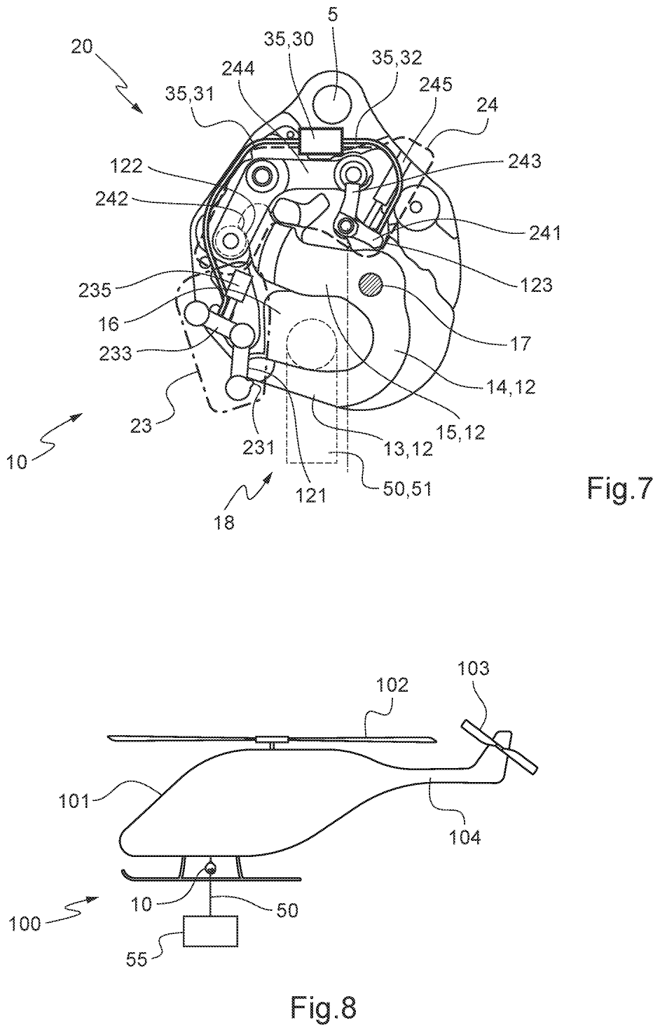

The double-locking hooking system 10 may also comprise an emergency release device 35 provided with two wires 31, 32 and an emergency actuator 30, as shown in FIG. 7. The emergency actuator 30 is connected to the two wires 31, 32 in order to simultaneously cause the two wires 31, 32 to move identical distances. Each of the two wires 31, 32 is connected to a single immobilization device 21, 22, 23, 24 and each of the two immobilization devices 21, 22, 23, 24 is connected to a wire 31, 32.

The wires 31, 32 allow the movement of the stops 231, 241, 242 of the two immobilization devices 23, 24 to be controlled, possibly via a connecting rod 233, 243, 244.

Thus, the emergency actuator 30 may simultaneously control the activation of the two immobilization devices 21, 22, 23, 24 in order to release the hook 12 and allow it to move to the open position 19 so as to release the sling 50 attached to the hooking system 10, for example in the event of an emergency.

The emergency actuator 30 may comprise a manual control to be actuated by an operator, for example a member of the crew of the aircraft equipped with the hooking system 10. The emergency actuator 30 may also comprise an electric motor, a jack, and/or a pyrotechnic device.

FIG. 8 shows an aircraft 100 provided with an airframe 101 and, for example, a lift rotor 102 arranged above the airframe 101 and/or an auxiliary rotor 103 possibly arranged at the end of a tail boom 104 of the airframe 101. The aircraft 100 also comprises a hooking system 10 attached beneath the airframe 101, for example via the hole 5. One end of a sling 50 is hooked to the hook 12 of the double-locking hooking system 10, via a loop 51 or a ring secured to the sling 50. A payload 55 is attached to the other end of this sling 50 in order to be able to be transported by the aircraft 100.

Naturally, the present disclosure is subject to numerous variations as regards its implementation. Although several embodiments are described above, it should readily be understood that it is not conceivable to identify exhaustively all the possible embodiments. It is naturally possible to envisage replacing any of the means described by equivalent means without going beyond the ambit of the present disclosure.

What is claimed is:

1. A double-locking hooking system comprising a structure, a hook that is able to move in relation to the structure between a closed position and an open position, and an immobilization system for immobilizing the hook in the closed position,
the immobilization system comprising at least two immobilization devices, each immobilization device comprising at least one movable stop, the stops being in contact with the hook when the hook is in the closed position, each immobilization device immobilizing the hook in the closed position, by means of its at least one stop, independently of the other immobilization device,
wherein each immobilization device comprises an actuator controlling the movement of its at least one stop.

2. The hooking system according to claim 1,
wherein the stops are in contact with the hook separately for each immobilization device when the hook is in the closed position.

3. The hooking system according to claim 1,
wherein the actuator comprises an electric motor and/or a jack.

4. The hooking system according to claim 1,
wherein at least an immobilization device comprises at least one connecting rod that is able to rotate and is provided with the stop of the immobilization device, the actuator controlling the movement of the connecting rod.

5. The hooking system according to claim 4,
wherein one of the immobilization devices comprises an immobilization connecting rod that is able to rotate and comprises the stop, the actuator acting on the immobilization connecting rod.

6. The hooking system according to claim 4,
wherein one of the immobilization devices comprises a single stop and two connecting rods that are able to rotate, the two connecting rods comprising a swiveling connecting rod and a locking connecting rod, the swiveling connecting rod comprising a first arm and a second arm and the locking connecting rod comprising a third arm, the first arm comprising the stop, the third arm bearing against the second arm in order to prevent the swiveling connecting rod from moving when the hook is in the closed position, the actuator acting on the third arm in order to release the second arm and allow the swiveling connecting rod to move.

7. The hooking system according to claim 5,
wherein one of the immobilization devices comprises a single stop and two connecting rods that are able to rotate, the two connecting rods comprising a swiveling connecting rod and a locking connecting rod, the swiveling connecting rod comprising a first arm and a second arm and the locking connecting rod comprising a third arm, the first arm comprising the stop, the third arm bearing against the second arm in order to prevent the swiveling connecting rod from moving when the hook is in the closed position, the actuator acting on the third arm in order to release the second arm and allow the swiveling connecting rod to move, and wherein the immobilization connecting rod and the swiveling connecting rod are able to move about the same pivot axis.

8. The hooking system according to claim 4,
wherein one of the immobilization devices comprises two stops and two connecting rods that are able to rotate and are provided respectively with the two stops, the two connecting rods comprising a swiveling connecting rod and a locking connecting rod, the swiveling connecting rod comprising a fourth arm and a fifth arm and the locking connecting rod comprising a sixth arm and a seventh arm, the fourth arm comprising one of the two stops, the sixth arm bearing against the fifth arm in order to prevent the swiveling connecting rod from moving when the hook is in the closed position, the seventh arm comprising the other of the two stops, the actuator acting on the locking connecting rod in order to release the fifth arm and allow the swiveling connecting rod to move.

9. The hooking system according to claim 1,
wherein the hook comprises a lower beam, a lateral part, a top part and an open space arranged between the lower beam and the top part, the hook being able to rotate in relation to the structure in the lateral part or the top part, at least one of the immobilization devices comprises a single stop bearing against a first part chosen from the lateral and top parts and the lower beam when the hook is in the closed position and another of the immobilization devices comprises a single stop bearing against a second part chosen from the lateral and top parts and the lower beam when the hook is in the closed position.

10. The hooking system according to claim 1,
wherein at least one of the immobilization devices comprises two stops.

11. The hooking system according to claim 10,
wherein the hook comprises a lower beam, a lateral part, a top part and an open space arranged between the lower beam and the top part, the hook being able to rotate in relation to the structure in the lateral part or the top part, one of the immobilization devices comprises a single stop bearing against a first part chosen from the lateral and top parts and the lower beam when the hook is in the closed position and the other immobilization device comprises two stops respectively bearing against a second part and a third part chosen from the lateral and top parts and the lower beam when the hook is in the closed position.

12. The hooking system according to claim 1,
wherein the hooking system comprises an emergency release device provided with two wires and an emergency actuator connected to the two wires, each of the two wires being connected to an immobilization device and each of the two immobilization devices being connected to a wire.

13. The hooking system according to claim 12,
wherein the emergency actuator comprises at least a manual control, an electric motor, a jack or a pyrotechnic device.
